(19) United States
(12) Patent Application Publication
(10) Pub. No.: US 2002/0138287 A1
(43) Pub. Date: Sep. 26, 2002

(54) Method and system for inter-enterprise agent communication and service invocation

(76) Inventors: Qiming Chen, Sunnyvale, CA (US); Igor Kleyner, Pacifica, CA (US); Meichun Hsu, Los Altos Hills, CA (US)

Correspondence Address: HEWLETT-PACKARD COMPANY, Intellectual Property Administration, P.O. Box 272400, Fort Collins, CO, 80527-2400, US

(21) Appl. No.: 09/817,958

(22) Filed: Mar. 26, 2001

(51) Int. Cl. G06F 17/60; G06F 15/16

(52) U.S. Cl. 705/1; 709/202

(57) ABSTRACT

An inter-enterprise communication and service invocation mechanism for enabling communication between agents in different domains and the invocation by a first agent in a first domain (e.g., a first enterprise) of services offered by an agent in a second domain. Each domain has a point of presence for accessing agents and services provided thereby. The point of presence can be a coordinator in a domain that includes a plurality of agents. The coordinator first registers a send-message service with a service bus (e.g., E-speak service bus). During registration, the coordinator provides a client-side interface for accessing the messaging service of the coordinator. When an agent in another domain (e.g., a second enterprise) communicates with agents in the first domain, the send-message service of the coordinator is employed. Specifically, the message is directed to the point of presence (POP), which is the coordinator of the first domain. The message is then received by the coordinator and routed to the intended recipient agent.

### FIELD OF THE INVENTION

The present invention relates generally to electronic commerce (E-commerce) automation, and more particularly, to a unified messaging interface method and system for inter-enterprise agent communication and service invocation.

### BACKGROUND OF THE INVENTION

In recent years, there has been much research in the use of software agent technology to support the automation of electronic commerce (E-Commerce). A world is envisioned where tasks that are normally performed by individuals can be handled by software agents. Examples of such tasks found in a company may include finding a suitable product for purchase, generating requests of quotes, negotiating price of the product, generating purchase orders, responding to requests for quotes, processing payment information, and shipping the product.

One important and necessary component to enable the automation of electronic commerce through the use of software agents is the ability to communicate information between agents even when the agents are disposed in different enterprises.

One reason that conventional agent infrastructures have difficulty in this area is that the infrastructures are primarily designed and tailored for intra-enterprise agent cooperation (i.e., cooperation of agents within a single enterprise). These approaches typically employ a central coordinator to manage agent interaction and are based on what is commonly referred to as an “agent coordination model.” Unfortunately, the agent coordination model has limitations especially when applied to inter-enterprise cooperation or communication. Such a model assumes that agents are formed in groups or domains. Each group is then provided with a coordinator for providing services to the agents, such as a naming service and a resource directory service. Agents in a group rely on these services to communicate and cooperate.

While this model works reasonably well for the agents belonging to the same enterprise, it unrealistically requires that the agents belonging to different enterprises form a single agent group or domain. For example, it is very unlikely that a buyer agent for a retailer and a seller agent for a supplier be in the same agent group or under the same coordination. In fact, most E-Commerce applications are based on inter-enterprise business partnerships, where agents across enterprise boundaries are unlikely to be organized into the same group or under a centralized coordinator.

Although groups can be organized in a hierarchical fashion with higher level groups that include sub-groups when the agents are of the same enterprise, it appears to be very difficult, if not impossible, to implement such a hierarchy across enterprise boundaries. In other words, organizing agent groups into a hierarchy allows the addition of higher level groups with sub-groups, but does not relieve the difficulty of coordination across enterprise boundaries.

To summarize, from a software agent point of view, communication typically involves a central coordinator, which is commonly utilized for communication between agents in a single enterprise (i.e., agent intra-enterprise communication). However, when multiple enterprises are involved, the model that features a centralized coordinator breaks down.

Another possible solution to facilitate inter-enterprise agent communication is to use a service bus for agents to locate each other by using peer-to-peer communications. Conceptually, any agent, A, can register a “send-message” service, making it possible for another agent in a foreign domain to send a message to A, using that service. However, an interface diversity problem prevents such an approach from successfully being implemented. The interface diversity problem is the burden of (1) requiring every agent to register a messaging service in order to receive messages and (2) requiring every agent to maintain multiple client side messaging service interface stubs for all the agents it may need to have a contact with. As can be appreciated, the interface diversity problem makes the “conceptual” approach impossible to implement in such a way as to operate in real world applications where thousands of agents need to communicate with each other.

As can be appreciated, it is desirable to reduce the amount of code for enabling inter-enterprise communication that agents are required to store and maintain. Unfortunately, the current infrastructure requires that every agent register a messaging service in order to receive messages. Moreover, every agent is required to implement and maintain multiple client side messaging service interfaces for all the agents with whom it may need to communicate. As can be appreciated, these requirements are burdensome on the service bus (i.e., there would be too many interfaces for a service bus to register) and on the agents (i.e., there would be too many interfaces for the agent to store and maintain).

Furthermore, it is often the case that once an agent reaches a domain, it is desirable for the agent to be allowed to invoke certain services carried by the coordinator or other agents of that domain. Unfortunately, all those services must also be individually registered with the service bus in order to be invoked by the agent. Consequently, the prior art infrastructure does not provide a scalable solution from a service invocation point of view.

To summarize, from a service bus point of view, peer-to-peer communication can be accomplished through the use of a service bus. While the service bus provides many services that address issues such as security, authentication, authorization, billing, etc., the use of a service bus to enable communication between software agents in different enterprises involves solving several technical hurdles that stem from the interface diversity problem as it relates to using a messaging service and to service invocation.

Another shortcoming of prior art approaches to automate electronic commerce is the inability to provide a mechanism to enable inter-enterprise agent communication that functions or operates in an environment, where there are a large number of software agents. The ability of an approach to operate and function with a large number of software agents, which is a requirement of most real world applications, is referred to as scalability.

Based on the foregoing, there remains a need for a method and system for a mechanism to provide a unified messaging interface for inter-enterprise agent communication and service invocation and that overcomes the disadvantages set forth previously.

### SUMMARY OF THE INVENTION

One aspect of the present invention is the provision of an inter-enterprise communication mechanism for enabling communication between agents in different domains through the use of a service bus, a registered send-message service, and a coordinator in the domain receiving the communication.

Another aspect of the present invention is the provision of an inter-enterprise communication mechanism for allowing a first agent in a first domain (e.g., a first enterprise) to communicate with agents (e.g., a second agent) in a second domain (e.g., a second enterprise) through a point of presence (e.g., a coordinator in the second domain).

Another aspect of the present invention is the provision of inter-enterprise communication mechanism for allowing a first agent in a first domain to communicate with a second agent in a second domain by sending a message to a messaging service of the coordinator that is registered with a service bus (e.g., E-speak service bus).

Another aspect of the present invention is the provision of an inter-enterprise service invocation mechanism for allowing a first agent to invoke one or more services of a second agent in another domain via messages, thereby not requiring a continuous connection between the first agent and the second agent.

Another aspect of the present invention is the provision of an inter-enterprise service invocation mechanism for allowing an agent to invoke with messages one or more services of another agent in another domain through a coordinator without having to first register the services with a service bus.

Another aspect of the present invention is the provision of an inter-enterprise service invocation mechanism for allowing an agent to invoke with messages one or more services of a coordinator in another enterprise without having to first register the services with a service bus.

Another aspect of the present invention is the provision of an inter-enterprise service invocation mechanism for allowing an agent to invoke one or more services of another agent in another domain in an asynchronous manner, thereby reducing the likelihood that an agent whose service may be in high demand experiences failure (e.g., a crash).

According to one embodiment, the inter-enterprise service communication and service invocation mechanism of the present invention includes a coordinator in a first domain. The first domain includes a plurality of agents. The coordinator can provide different services to the agents, such as a naming service for converting an agent name into a physical address of the agent and a directory service for allowing another agent to determine the services offered by the agents related to the coordinator. The coordinator first registers a send-message service with a service bus (e.g., E-speak service bus). During registration, the coordinator provides a client-side interface for accessing the messaging service. An agent in a second domain then communicates with agents in the first domain by employing the send-message service of the coordinator. Specifically, the message is directed to a point of presence (POP), which is the coordinator of the first domain. The message is then received by the coordinator and routed to the intended recipient agent.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a block diagram illustrating the inter-enterprise agent communication and service invocation mechanism according to one embodiment of the present invention that enables communication and service invocation between agents in different enterprises.

FIG. 2 is a flowchart that illustrates the processing steps performed by the unified messaging interface to communicate messages between a first agent in a first enterprise and a second agent in a second enterprise.

FIG. 3 is a block diagram illustrating the use of a unified messaging interface for inter-enterprise service invocation.

FIG. 4 is a block diagram illustrating a publish and subscribe mode of communication between agents in different enterprises in accordance with one embodiment of the present invention.

FIG. 5 is a block diagram illustrating a common client-side interface for message services of coordinators in different domains in accordance with one embodiment of the present invention.

### DETAILED DESCRIPTION OF THE PREFERRED EMBODIMENT

A method and system for enabling inter-enterprise agent communication and service invocation are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

The inter-enterprise agent communication and service invocation of the present invention delivers messages based on service invocation, in order to use the services of a service bus to control inter-enterprise communication. Furthermore, the inter-enterprise agent communication and service invocation mechanism of the present invention provides a point-of-presence approach that addresses the issues related to the scalability of agent-mediated E-Commerce automation described earlier.

The inter-enterprise agent communication and service invocation mechanism of the present invention provides a Point of Presence (POP) approach that supports inter-enterprise agent communication using a service bus (e.g., HP's E-Speak service bus) and a unified messaging interface. The use of the service bus allows agents to communicate across enterprise boundaries, with fine-grained access control, firewall traversal, and other infrastructure services.

One aspect of the inter-enterprise agent communication and service invocation mechanism of the present invention is that each agent domain (e.g., enterprise) only registers the messaging service of the domain coordinator with the service bus. In this manner, the messaging service of the coordinator becomes the single gateway to the agent domain. Within the domain, the coordinator can forward messages to other agents through intra-domain agent communication, which is well-known to those of ordinary skill in the art.

Furthermore, the above service interface can be made standard for all the agent domains. One advantage of the present invention is that it obviates the need for each agent to register an individual message service before enabling agents in foreign domains to reach it. Another advantage is that with a standard message service interface, every agent only needs a common client-side interface for invoking the above messaging service. For example, the agent domain name may be used as a parameter for contacting any agent in any foreign domain. The messages are then routed to the final recipient by the coordinator of that domain.

Although the proposed mechanisms are independent of the underlying agent infrastructure, preferably the proposed mechanisms are implemented by using the E-Carry agent infrastructure that is developed at Hewlett-Packard (HP) Labs of Palo Alto, Calif., the assignee of the present patent application.

An E-Carry agent has the ability to load, maintain and start servers and applications dynamically. It also contains an embedded Web server with servelet functionality, enabling its state to be accessed or updated through a browser. Adding the proposed capabilities allows us to provide a migration from the traditional agent infrastructure to a dynamic and distributed middleware framework.

Inter-Enterprise Agent Communication with Unified Messaging Interface

Agent in the same group, referred to as the agent domain, can communicate using the naming service provided by the coordinator of that domain. However, agents in different enterprises may not form a single agent domain. In this regard, the inter-enterprise agent communication and service invocation mechanism (IEACSIM) employs a service bus (e.g., E-speak service bus) to enable agents to locate each other for peer-to-peer communication across domains.

The service bus addresses such issues as firewall, security, access control, and even billing. In this embodiment, an HP E-Speak service bus, which is an interface based service provisioning and invocation framework with multiple interconnected E-Speak cores is utilized. An E-Speak core provides a set of predefined and extensible infrastructure services including authentication, authorization, billing, etc. It is noted that other types of service buses, such as CORBA-like middleware, may be employed.

The inter-enterprise agent communication and service invocation mechanism (IEACSIM) involves an agent, A, registering a send-message service with the service bus thereby, making it possible for another agent in a foreign domain to send a message to agent A by invoking this service. Furthermore, the inter-enterprise agent communication and service invocation mechanism (IEACSIM) avoids the interface diversity problem, mentioned earlier, by requiring every agent only to implement and maintain a single client-side messaging service interface stub for all the domains it may need to have a contact with. In this regard, the IEACSIM of the present invention greatly reduces the number of interfaces that need be registered with the service bus and the number of interface stubs that an agent is required to maintain and keep.

Furthermore, as described in greater detail hereinafter, the inter-enterprise agent communication and service invocation mechanism (IEACSIM) of the present invention allows agents to invoke services that are carried by the coordinator or other agents of that domain via messages. The IEACSIM of the present invention employs a unified messaging interface (UMI) to provide unifies the messaging interface for inter-enterprise agent communication. The coordinator of every agent domain carries a messaging service, and registers this service with a service bus (e.g., E-Speak service bus). This service, which is referred to herein also as the Point of Presence (POP), then becomes the single entrance to the agent domain.

Inside the domain, the coordinator can forward messages to other agents. Thus, it is unnecessary for each agent to register an individual message service, since the coordinator provides a gateway for any foreign agent to reach any agent in that agent-domain. Moreover, services provided either by the coordinator or by other agents in that domain may be invoked through messages. By enabling the invocation of services via messages, the need of registering every individual service is also eliminated.

Preferably, a single POP, is maintained for both communication and service invocation. However, it is noted that more than one POP can be opened as the need arises or to suit a particular application (i.e., there is no restriction on the number of messaging services that may be registered for a domain or enterprise).

Registering only the general messaging service also simplifies and unifies the client interface for sending messages. Every software agent only needs to be provided with a “standard” client-side stub for invoking the above messaging service, with the domain name encapsulated in the message envelop. By invoking this message service, the agent can contact any agent in any foreign domain, with messages routed by the coordinator of that domain.

Through the messages an agent sends to a foreign domain, services provided by the agents (including the coordinator) of that domain can be invoked, and such invocation is message-based without keeping continuous connection.

Further details about the messaging service used for inter-enterprise agent communication are described hereinbelow. On the server-side, the messaging service provided by the coordinator of an agent domain, D, is registered with E-Speak service bus. The interface of this service includes a single method

void sendMsg(String message).

The interface name, say AgentMsgService, plus a property description indicating the domain name, uniquely identify this service. In an intra-domain message, the destination is simply expressed by the receiver's name. In an inter-domain message, the destination is expressed by

espeak: domain_name/agent_name,

where espeak is the service bus, a concept at a higher-level than transport. For example, when the present invention is extended to use http as the service bus, the logical address of an agent is

http:domain_name/agent_name.

In this case, the Web server embedded in an E-Carry agent is used. On the “client-side”, a standard implementation of the above interface is embedded to each E-Carry agent, as the “e-speak message dispatcher”.

Inter-Enterprise Communication and Service Invocation Mechanism 100

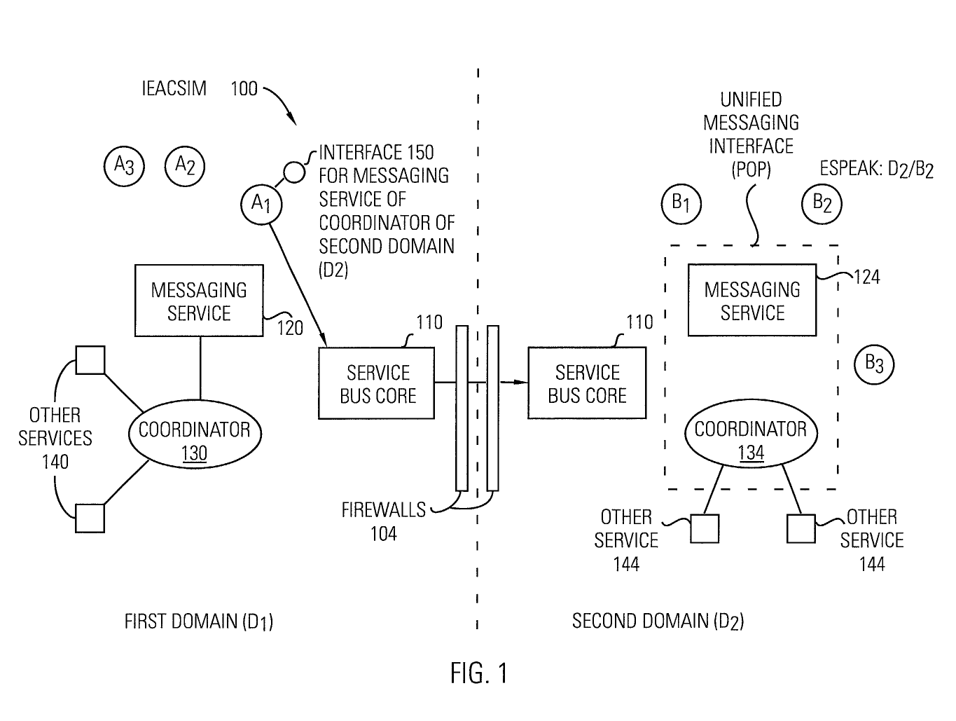

FIG. 1 is a block diagram illustrating the inter-enterprise agent communication and service invocation mechanism (IEACSIM) 100 according to one embodiment of the present invention that enables communication and service invocation between agents in different enterprises. The inter-enterprise agent communication and service invocation mechanism (IEACSIM) 100 enables both communication and service invocation between a first domain (D1), which can, for example, be a first enterprise, and a second domain (D2), which can, for example, be a second enterprise. It is noted that each domain may be separated by firewalls 104. IEACSIM 100 includes a service bus 110 for providing inter-enterprise services. For example, the Hewlett-Packard's E-speak service bus provides a dynamic firewall traversal that makes resources behind a firewall available for specific tasks to authorized users, according to a company's predetermined access policies. The cross-firewall connection is immediately closed when a task is complete. In this manner, the HP E-speak service bus allows safe passage of data between business partners without the need for a virtual private network (VPN) or other special configuration that is expensive and time-consuming to implement. Another inter-enterprise service is an access control mechanism that scales well in terms of users and resources (files and service) and that is suited for Internet-wide applications. For further information the E-speak service bus, please refer to the following web address: http://www.e-speak.net.

The IEACSIM 100 also includes a send-message service (e.g., send-message service 120 and send-message service 124) that is provided by the coordinator of each domain. For example, coordinator 130 and coordinator 134 provide send-message services 120 and 124, respectively, to allow software agents outside of the domain to communicate with agents in the domain. Coordinator 130 and coordinator 134 can have other services (e.g., services 140 and 144) that can, for example, be a naming service and a directory service.

The IEACSIM 100 also includes a client-side interface (e.g., interface 150) for each messaging service. The client side interface is utilized by an agent outside of the domain to communicate with or invoke services of agents in the domain.

Referring to FIG. 1, when agent A1 in a first domain (D1) attempts to contact an agent B2 in a second domain (D2) that is different or foreign to the first domain (D1), agent A1 invokes function sendMsg, that is registered with a service bus (e.g., E-Speak service bus) by the coordinator of the second domain (D2) as

Name=‘AgentMsgService’ and Description=‘D2’

to send a message with destination espeak: D2/B2. The message is first received by the coordinator of the second domain (D2), and then forwarded to agent B2 by the coordinator. In the first step, a service bus infrastructure service (e.g., a service offered by the E-Speak service bus) is called. In the second step, a local naming service that is provided by the domain coordinator is employed. If the sender intends to invoke a service that is provided by the coordinator or another agent of the second domain (D2), the result of that service is sent back or returned to the sender via the service bus.

With the E-Speak service bus, agents from different domains can also communicate in the publish/subscribe mode. For example, when an agent intends to buy some electronic parts, instead of checking the vendor agents one by one, the agent can publish an availability-check message. Then, the service bus (e.g., E-Speak service bus) can broadcast this message to all the vendor agents who subscribe this message.

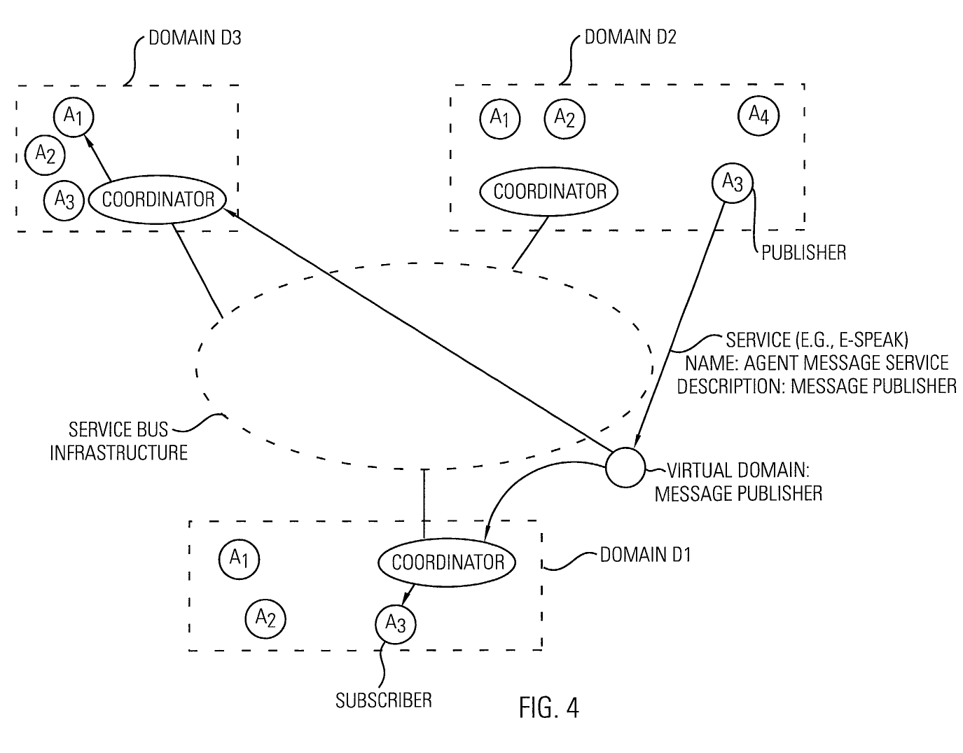

The message publish server carried by a software agent (e.g., an E-Carry agent) and registered with the E-Speak service bus, implements the same interface as AgentMsgService, with a single method sendMsg(String message). Referring to FIG. 4, the message publish server is registered as a virtual agent domain: AgentMsgPublisher. Therefore, when an E-Carry software agent publishes a message, it sends the message to the AgentMsgPublisher server by employing espeak:AgentMsgPublisher as the address, which is similar to sending a message to an agent domain.

To subscribe to message AvailabilityCheck, for instance, a subscribing agent sends the following message to espeak:AgentMsgPublisher:

<MESSAGE type=“SUBSCRIBE” from=“espeak:D₂/A₃” to=“espeak:AgentMsgPublisher” interpreter=“xml.default”>

<CONTENT><MESSAGE_NAME> AvilabilityCheck </MESSAGE_NAME></CONTENT></MESSAGE>

Unified Messaging Interface Processing

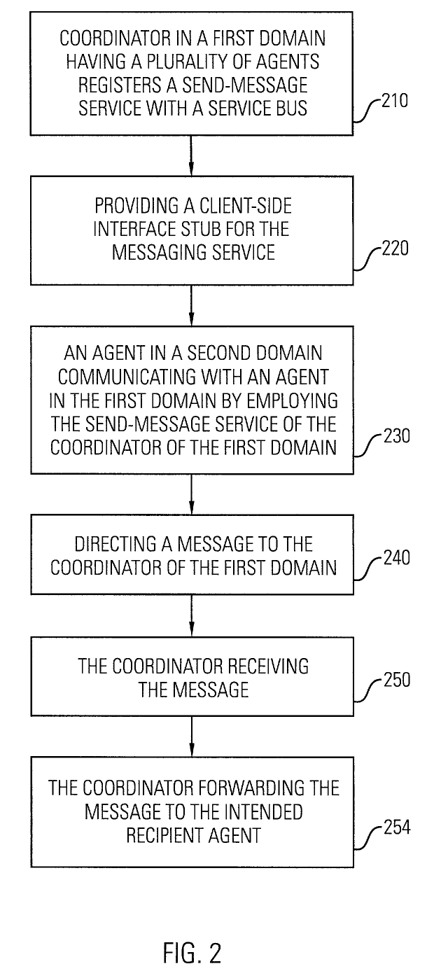

FIG. 2 is a flowchart that illustrates the processing steps performed by the unified messaging interface to communicate messages between a first agent in a first enterprise and a second agent in a second enterprise. In step 210 a coordinator of a first domain (e.g., a first enterprise) that has a plurality of agents registers a send-message service with a service bus. In step 220, the coordinator provides a client-side interface (e.g., an interface stub) for the messaging service that can be employed by other agents in different domains (e.g., other enterprises) to communicate with the agents in the first domain. It is noted that step 220 can be part of the registration process of step 210.

In step 230 an agent in a second domain (e.g., a second enterprise) communicates with an agent in the first domain by employing the client-side interface of the messaging service of the coordinator. In step 240, a message from the agent in the second domain is directed to the coordinator, which serves as a point of presence for agents in the first domain. In step 250, the coordinator receives the message. In step 254, the coordinator forwards or routes the message to the intended recipient (i.e., the intended receiving agent) in the first domain. It is noted that steps 240, 250, and 254 can be part of the step of employing the client-side interface of the messaging service of the coordinator to communicate between the first agent and second agent.

Inter-Enterprise Service Invocation

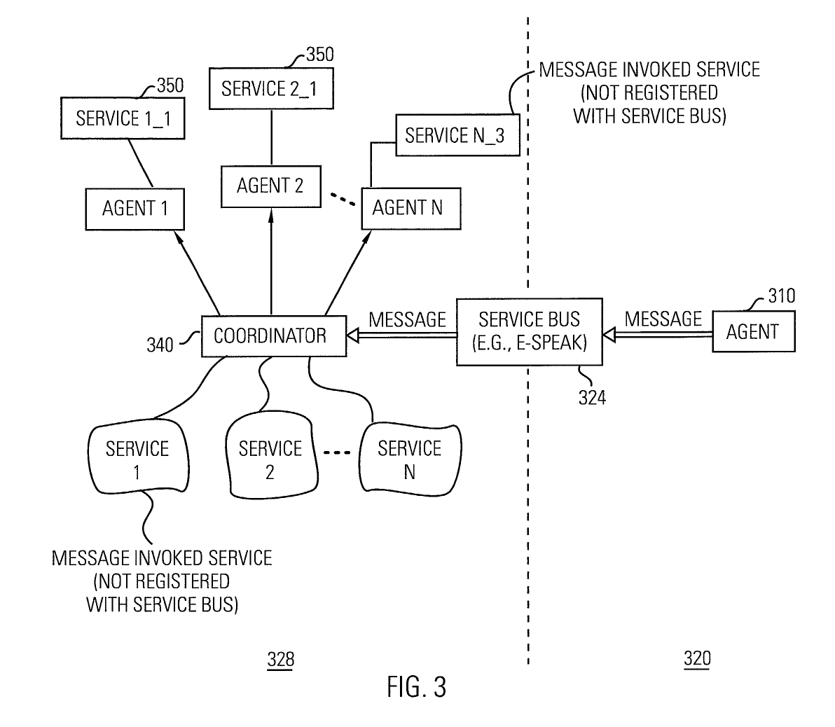

FIG. 3 is a block diagram illustrating the use of a unified messaging interface for inter-enterprise service invocation. An agent 310 in a first enterprise 320 sends a message through a service bus 324 to a coordinator 340 of a second enterprise 328 requesting a particular service. For example, the service can be a service 330 provided by the coordinator 340 (e.g., service_1 service_2, . . . , service_N) or a service 350 (e.g., service_1_1, or service_2_1, and service_N_3) provided by one of the agents (e.g., agent1, agent2, . . . , agentN).

It is noted that by providing a point of presence access to services offered by agents or the coordinator in the second enterprise 328, the services of each agent and the services of the coordinator do not need to be registered individually with the service bus. Consequently, the unified messaging interface provides a solution to the interface diversity problem by reducing the burden of each service to register with the service bus and for each agent to have a client-side interface for each service of interest. In contrast, the unified messaging interface only requires that an agent have the client-side of the point of presence gateway (e.g., the client-side interface for the coordinator of an enterprise) to invoke services offered by that enterprise.

Common Client-Side Interface for Message Services

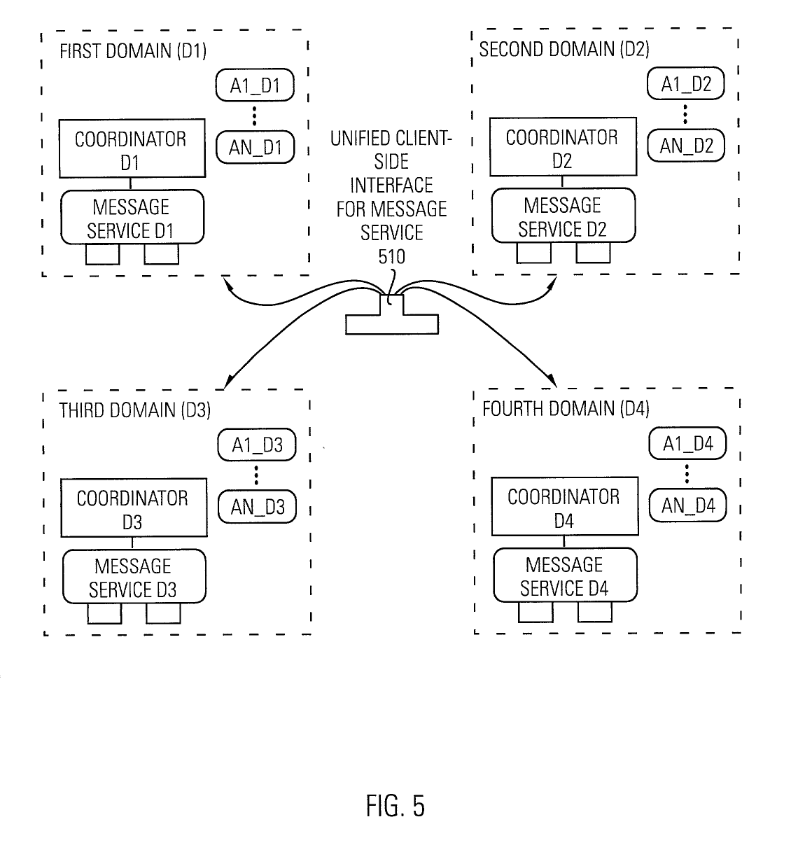

FIG. 5 is a block diagram illustrating a common client-side interface for message services of coordinators in different domains in accordance with one embodiment of the present invention. FIG. 5 illustrates four different domains (i.e., domains D1, D2, D3 and D4). Each domain has a plurality of software agents (e.g., agents A1 D1, A2_D1 . . . , AN_D1 for domain D1, agents A1_D2, A2_D2, . . . , AN_D2 for domain D2, agents A1_D3, A2_D3, . . . , AN_D3 for domain D3, agents A1_D4, A2_D4, . . . , AN_D4 for domain D4) and a coordinator (e.g., coordinator D1, coordinator D2, coordinator D3, and coordinator D4) for the agents of each domain.

As described previously, one aspect of the present invention is the provision a send-message service (e.g., message service D1, message service D2, message service D3, message service D4) by the each coordinator of each domain. The coordinator acts as a gateway or point-of-presence for messages directed to agents in that domain.

It is noted that the message service for each domain may have a different client side interface for use by agents external to the domain of the agent to which the message is directed. In this case, an agent is required to carry the implementation of every send-message service corresponding to the coordinator of each domain, where messages may be directed. It is noted that the burden of carrying interfaces by software agents is greatly reduced by the POP approach of the present invention since only a single send-message interface is needed to communicate with any agent in a domain instead of having to carry a separate interface for each agent in the domain.

However, preferably, a common client-side interface 510 is provided that may be used to access or invoke the message service of different domains (e.g., message service D1, message service D2, message service D3, message service D4). In this manner, the burden of carrying interfaces by software agents is further reduced.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for enabling communication between a first agent in a first domain and a second agent in a second domain comprising the steps of:
a) a coordinator in the first domain registering a send-message service with a service bus; and
b) the second agent in the second domain communicating with first agent by employing the service bus, the registered send-message service, and the coordinator in the first domain;
wherein the method solves the interface diversity problem and does not require a central coordinator.

2. The method of claim 1 wherein the step of the second agent in the second domain communicating with first agent by employing the service bus, the registered send-message service, and the coordinator in the first domain includes
i) the coordinator providing a client-side interface for the send-message service that can be employed by other agents in different domains to communicate with the agents in the first domain; and
ii) the second agent in a second domain communicating with an agent in the first domain by employing the client-side interface for the send-message service of the coordinator.

3. The method of claim 2 wherein the step of the second agent in a second domain communicating with an agent in the first domain by employing the client-side interface for the send-message service of the coordinator includes
i) directing a message from the second agent to the coordinator, which serves as a point of presence for agents in the first domain;
ii) the coordinator receiving the message and forwarding the message to the intended recipient agent.

4. The method of claim 1 wherein the coordinator is a point-of-presence for communication directed to agents in the first domain by agents external to the first domain.

5. The method of claim 1 wherein the service bus is the E-speak service bus.

6. The method of claim 1 wherein the service bus is the HTTP service bus.

7. The method of claim 1 wherein the service bus provides one of dynamic firewall transversal services, access control services, security services, billing services, authentication services, authorization services, and other predefined infrastructure services.

8. The method of claim 1 wherein the coordinator provides one of naming services, resource directory services, and send-message service.

9. The method of claim 3 wherein the step of directing a message from the second agent includes
invoking a send-message service provided by the service bus;
wherein the step of the coordinator receiving the message and forwarding the message to the intended recipient agent includes
employing a local naming service to forward the message to the first agent.

10. The method of claim 9 wherein the step of invoking a send-message service provided by the service bus includes specifying a domain name and receiver agent name.

11. The method of claim 1 wherein the first agent and the second agent communicate in a publish and subscribe mode.

12. The method of claim 1 wherein the first domain is a first enterprise and the second domain is a second enterprise.

13. A system for enabling communication between agents in different domains comprising:
a) a service bus for providing infrastructure services;
b) a coordinator in a first domain having a send-message service that is registered with the service bus;
c) an agent in a second domain; wherein the agent in the second domain sends a message directed to an agent in the first domain by employing the send-message service of the coordinator;
wherein the coordinator provides a point-of-presence gateway for receiving messages directed to agents in the first domain and forwarding the message to the intended recipient agent.

14. The system of claim 13 wherein the delivery of messages between agents is based on service invocation and the infrastructure services provided by the service bus, and wherein the system does not require a centralized coordinator.

15. The system of claim 13 wherein agents communicate messages with other agents across domains by invoking a send-message service provided by a service bus, and wherein the system provides a point-of-presence approach to address the interface diversity problem.

16. The system of claim 13 wherein each agent is required to keep only the client-side interface of the coordinator in order to communicate with agents in the first domain.

17. The system of claim 13 wherein only a single send-message service of the coordinator need be registered with the service bus to enable agents external to the first domain to communicate with every agent in the first domain.

18. A method for enabling inter-enterprise agent communication comprising the steps of:
a) grouping agents into a first group in a first domain;
b) assigning a coordinator to the agents in the first group;
c) registering a send-message service of the coordinator with a service bus;
d) the coordinator receiving messages from a second domain; wherein the messages are directed to an agent in the first group; and
e) the coordinator forwarding the messages to an intended recipient agent;
wherein the service bus provides inter-enterprise communication services between the first domain and the second domain.

19. The method of claim 18 wherein the first domain is disposed in a first enterprise and the second domain is disposed in a second enterprise.

20. The method of claim 18 wherein the service bus provides one of dynamic firewall transversal services, access control services, security services, billing services, authentication services, authorization services, and other predefined infrastructure services.
